(19) United States
(12) Patent Application Publication
(10) Pub. No.: US 2010/0161083 A1
(43) Pub. Date: Jun. 24, 2010

(54) Control system, control apparatus, control method and computer readable medium

(75) Inventors: Yuri Kishita, Yokkaichi-shi (JP); Kazuhito Fujita, Yokkaichi-shi (JP)

Correspondence Address: OLIFF & BERRIDGE, PLC, P.O. BOX 320850, ALEXANDRIA, VA, 22320-4850, US

(73) Assignees: AUTONETWORKS TECHNOLOGIES, LTD., YOKKAICHI-SHI (JP); SUMITOMO WIRING SYSTEMS, LTD., YOKKAICHI-SHI (JP); SUMITOMO ELECTRIC INDUSTRIES, LTD., OSAKA-SHI (JP)

(21) Appl. No.: 12/654,060

(22) Filed: Dec. 9, 2009

(30) Foreign Application Priority Data
Dec. 23, 2008 (JP) 2008-326720

(51) Int. Cl. G05B 11/01

(52) U.S. Cl. 700/19

(57) ABSTRACT

With utilizing a function of a selection unit 105 in an application layer 101, a microprocessor receives operation requests from a plurality of applications 103, 104, selects a load as a controlled object corresponding to each of the received operation requests, selects an operational pattern to be performed by the selected load, and gives information about the selected load and the selected operational pattern to an output driver unit 106. The microprocessor creates a control signal and makes an input/output driver 107 implementing physical signal input/output in a platform layer 102 output the created control signal to the load represented by the information given by the function of the single output driver unit 106.

This non-provisional application claims priority under 35 U.S.C. §119(a) on Patent Application No. 2008-326720 filed in Japan on Dec. 23, 2008, the entire content of which is hereby incorporated by reference.

### BACKGROUND OF THE INVENTION

1. Field of the Invention

The present invention relates to a control system and a control apparatus that perform operation control of each load based on computer program. Furthermore, the present invention relates to a control system, control apparatus, control method and a computer readable medium that can implement simplifying the system, apparatus, method and the medium with utilizing computer program having a structure for saving a memory, can respond flexibly to increase or decrease of multi functions for each load and can improve development efficiency.

2. Description of Related Art

It is known for a control apparatus utilizing a microprocessor and performing a control procedure based on computer program written on a ROM in the microprocessor that the computer program is written in a so-called embedding type of programming language. Generally, the computer program written in an embedding type of programming language is applied to an apparatus that performs only minimum processes per controlled objects and per functions in order to save resources, such as a memory, for simplifying the apparatus.

FIG. 11 is a schematic view showing a conventional configuration of computer program of a microprocessor. Particularly, FIG. 11 shows examples of conventional computer program utilized by a microprocessor provided in a control apparatus that controls operations of controlled objects (electrical load A and load B). In FIG. 11, each block represents a function implemented by computer program. Assume that computer program shown in FIG. 11 performs functions for controlling the electrical load A and the load B. As shown in FIG. 11, the computer program implements functions, such as a detection of an input signal, judgment of an operation condition for a load corresponding to the input signal, arbitration for outputting a signal to each load, an output of a signal to a load per operations, and the like. These functions correspond to (A) function and (B) function that are required to be implemented by application program. Further, these functions are implemented for the electrical load A as well as the load B.

### SUMMARY OF THE INVENTION

When such computer program is provided, a program code (executable file) per functions (i.e., many program codes) is created. All the program codes are previously stored on a memory and then read out by a CPU. Thus, the memory is occupied in proportion to each block shown in FIG. 11. In this case, the arbitration for the electrical load A is substantially the same as the arbitration for the load B. Furthermore, the arbitration for the electrical load A is not required to be performed simultaneously with the arbitration for the load B. Nevertheless, the function of arbitration for the electrical load A is implemented separately from the function of arbitration for the load B. In addition, although being not required for performing (A) function based on an application simultaneously with (B) function based on an application, the microprocessor is provided program for performing an operation that implements processes of an arbitration unit of the load A, separately from program for performing an operation that implements processes of an arbitration unit of the load B. In other wards, the microprocessor is provided two programs duplicating each other, although two programs are for performing substantially the same operation. Further, although a signal output unit per operations of the electrical load A conducts substantially the same as a signal output unit per operations of the electrical load B even with different waveforms depending on outputted signals, the microprocessor is provided two programs duplicating each other, being utilized for (A) function based on an application and for (B) function based on an application, and having no possibility to be utilized simultaneously.

In this configuration, there are many program codes that are not utilized simultaneously, and the program codes cause increase of memory occupancy.

Recently, a motor vehicle (e.g., a car) is provided a wide variety of functions and/or complex functions. Thus, one implemented function corresponds to not only one controlled object in a field of a recent control apparatus adapting for motor vehicle, although one implemented function in a field of an old control apparatus adapting for motor vehicle has substantially corresponded to only one controlled object. For example, assume that a motor vehicle driver intends to blink a direction indicator lamp (winker). In an old control apparatus adapting for motor vehicle, a function indicating a traveling direction has substantially corresponded to only a direction indicator lamp as a controlled object. However, a direction indicator lamp in a recent control apparatus adapting for motor vehicle may be a controlled object for implementing a function notifying information toward a user outside of the motor vehicle as well as a controlled object for implementing the function indicating a traveling direction. Thus, a conventional control apparatus adapting for motor vehicle is provided and stores a program code for a blinking control based on a direction indicating function and another program code for a blinking control based on an information notifying function, in order to perform a blink control of the direction indicator lamp. In other words, the conventional control apparatus adapting for motor vehicle has a program code per functions in a one-to-one correspondence manner. In FIG. 11, an operation a of the electrical load A and an operation b of the electrical load B for the function (A) based on an application are substantially the same as those for the function (B) based on an application.

Configurations described above have some controlled objects each of which contributes to a plurality of functions. In these configurations, a program code is required per functions and per operations of each controlled object. In short, these configurations require many program codes. Thus, these configurations inefficiently utilize a memory because the memory is occupied by many program codes.

In a control apparatus that controls operations of loads with utilizing a microprocessor, most of controlled objects are generally controlled by switching between the on and off state, although some controlled objects (loads), such as motor, require extra information, such as rotation number information. For example, a process creating a control signal is substantially the same for these controlled objects. Even though such processes are for different controlled objects, a memory stores program codes implementing signal output functions for these controlled objects (loads), as shown in FIG. 11. When there are many executable application programs implementing substantially the same function as each other, the memory stores program codes implementing signal output functions for all the application programs.

In the case described above, a control signal is sequentially output to a corresponding load in order to make each load perform an operation based on the control signal, instead of controlling all the loads simultaneously. Furthermore, the program codes are not accessed simultaneously that occupy the memory. Nevertheless, the memory is occupied by the program codes corresponding to operations controlled by the microprocessor. Therefore, the memory is utilized inefficiently.

On the other hand, it is proposed in consideration of a wide variety of functions and/or complex functions about a control apparatus that makes a microprocessor read and execute program written in an object-oriented programming language (e.g., Japanese Patent Application Laid-Open No. 2008-77220). In that control apparatus, a memory is allocated when a process is motor carried out, and the memory is freed for other purpose after the process is motor carried out. Thus, the memory may be utilized efficiently. However, it requires e.g., a basic function (library) for making the microprocessor perform some processes, such as a process dynamically allocating the memory during the implementation of the program, to achieve that control apparatus. In a design of that control apparatus based on the object-oriented manner, it is expected that the memory is occupied by a library program code for implementing the basic function, the memory is dynamically allocated, the library is dynamically linked, and the like. Thus, because having excess memory capacity, that control apparatus based on the object-oriented manner can implement various functions even with utilizing the object-oriented computer program.

However, there is a memory capacity limitation in a control apparatus that utilizes a microprocessor and controls a load. Thus, the limited control apparatus utilizes computer program written in an embedding type of programming language. The object-oriented software configuration is not suitable for a control apparatus having a memory capacity limitation. In addition, even though having a process to be shared, a control apparatus utilizing a conventional computer program structure is inefficient because a memory is occupied by program codes for all loads (controlled objects) and all functions. Therefore, it may be desirable to utilize a process sharing among similar processes, to form a reusable configuration and to make a memory be occupied for the process sharing among similar processes by only single program code corresponding to the sharing among similar processes.

The present invention was made in view of such circumstances, and has a primary object to provide: a control system, control apparatus, control method, and a computer readable medium that, through applying an object-oriented concept into an embedding type of computer program, can implement simplifying the system, apparatus, method and the medium with utilizing computer program having a structure for saving a memory, and can improve development efficiency.

The above and further objects and features of the invention will more fully be apparent from the following detailed description with accompanying drawings.

### BRIEF DESCRIPTION OF THE DRAWINGS

FIG. 1 is a block diagram showing a configuration of a control system adapting for motor vehicle according to an embodiment 1;

FIG. 2 is a block diagram showing an inner configuration of an body ECU included in the control system adapting for motor vehicle according to the embodiment 1;

FIG. 3 is a function block diagram conceptually showing functions implemented by a CPU of a microprocessor included in the body ECU according to the embodiment 1;

FIG. 4 is a view illustrating an example of an operational pattern table stored on a ROM Of the body ECU according to the embodiment 1;

FIG. 5 is a view illustrating an example of a process in a case of the CPU functioning as an output driver unit;

FIG. 6 is a view illustrating an example of implementation, as a comparative example, for an object-oriented type of program performing a control process per controlled objects;

FIG. 7 is a flowchart illustrating an example of implementation for a procedure in a case of the CPU functioning as an output driver unit;

FIG. 8 is a view illustrating an example of an operational pattern table stored on a ROM of an body ECU according to an embodiment 2;

FIG. 9 is a flowchart illustrating an example of a procedure that a CPU functioning as a selection unit adds a new operational pattern corresponding to an operation request onto an operational pattern table;

FIG. 10 is a flowchart illustrating an example of a procedure that the CPU preferentially selects a controlled object and an operation based on a priority of an application program generating an operation request;

FIG. 11 is a schematic view showing a configuration of computer program of a conventional microprocessor.

### DESCRIPTION OF THE PREFERRED EMBODIMENTS

Hereinafter, embodiments of the present invention are described in detail with reference to drawings. In the following embodiments, the present invention is described in the context of a control system adapting for car as motor vehicle including an body ECU adapting for motor vehicle, as a control apparatus according to the present invention, which controls various controlled objects (on board body type equipment), such as a head light and a door.

### Embodiment 1

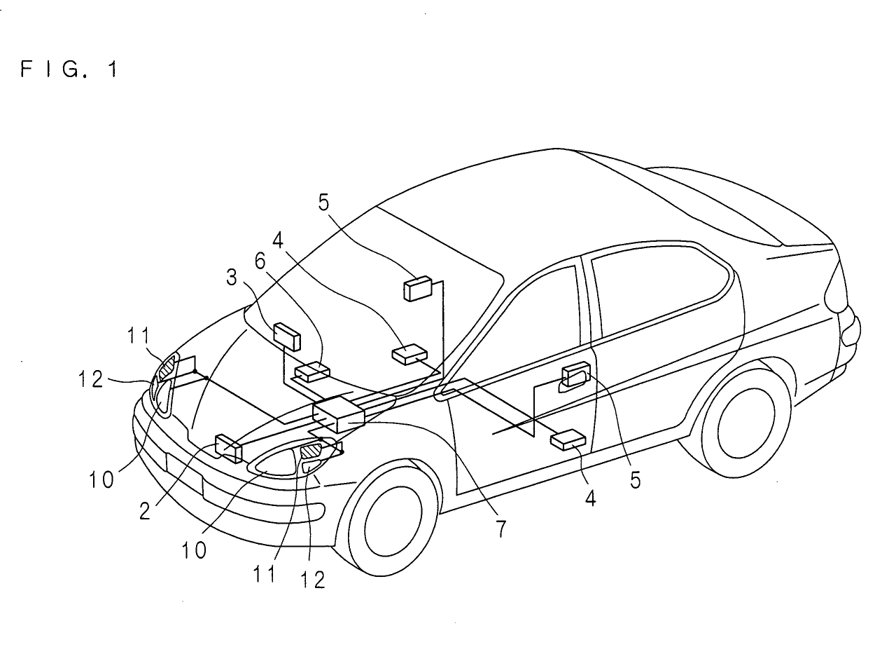

FIG. 1 is a block diagram showing a configuration of a control system adapting for motor vehicle according to an embodiment 1. The Control System Adapting for Motor Vehicle Includes: Head Lights (loads: controlled object devices) 10, 10, direction indicator lamps (loads: controlled object devices) 11, 11 and small lamps (loads: controlled object devices) 12, 12 arranged on both right and left sides of the front of a motor vehicle; a horn (load: controlled object device) 2 arranged on the front of the motor vehicle; a buzzer (load: controlled object device) 3 arranged in the motor vehicle; door open/close sensors 4, 4 arranged on door portions of the motor vehicle for detecting the opening and the closing of the doors; door lock sensors 5, 5 arranged on the door portions of the motor vehicle for detecting the locking of the doors; a key sensor 6 arranged in the motor vehicle for detecting a key; and an body ECU (control apparatus) 7 controlling all the components described above.

The head lights 10, 10, direction indicator lamps 11, 11 and the small lamps 12, 12 are respectively connected to the body ECU 7 and the body ECU 7 controls the “on” and “off” of them, respectively.

The horn 2 and the buzzer 3 are connected to the body ECU 7, and the body ECU 7 controls the sound signal of them.

The door open/close sensors 4, 4 and the door lock sensors 5, 5 are connected to the body ECU, and output signals to the body ECU 7 to inform of door open/close state or door lock state.

The key sensor 6 is connected to the body ECU 7, and outputs a signal to the ECU 7 to inform of detection results about existence of a key.

The body ECU 7 implements various functions based on signals output from the door open/close sensors 4, 4, the door lock sensors 5, 5 and/or the key sensor 6. For example, when it is recognized through the detections of the door lock sensors 5, 5 and the key sensor 6 that doors are locked externally with no keys in the motor vehicle stopping an engine, the body ECU 7 implements a keyless answerback function through outputting control signals to make the direction indicator lamps 11, 11 or the small lamps 12, 12 blink several times. For example, when it is recognized through the detections of door lock sensors 5, 5 that a door lock is tried to cancel with using an unauthorized key, the body ECU 7 implements a security answerback function through outputting control signals to make the horn 2 and/or the buzzer 3 emit sound signals and/or to make the head light 10 light.

In this embodiment 1, it is described about procedures of each component only for the keyless answerback function and the security answerback function. However, it should be noted that the body ECU 7, of course, may control the other load (actuator) as a controlled object to implement the other function.

It will be described about inner configuration and processes of the body ECU 7 for implementing various functions described above. The body ECU 7 includes a microprocessor described later and implements various functions through performing processes based on computer program stored on a ROM (Read Only Memory) arranged into the microprocessor.

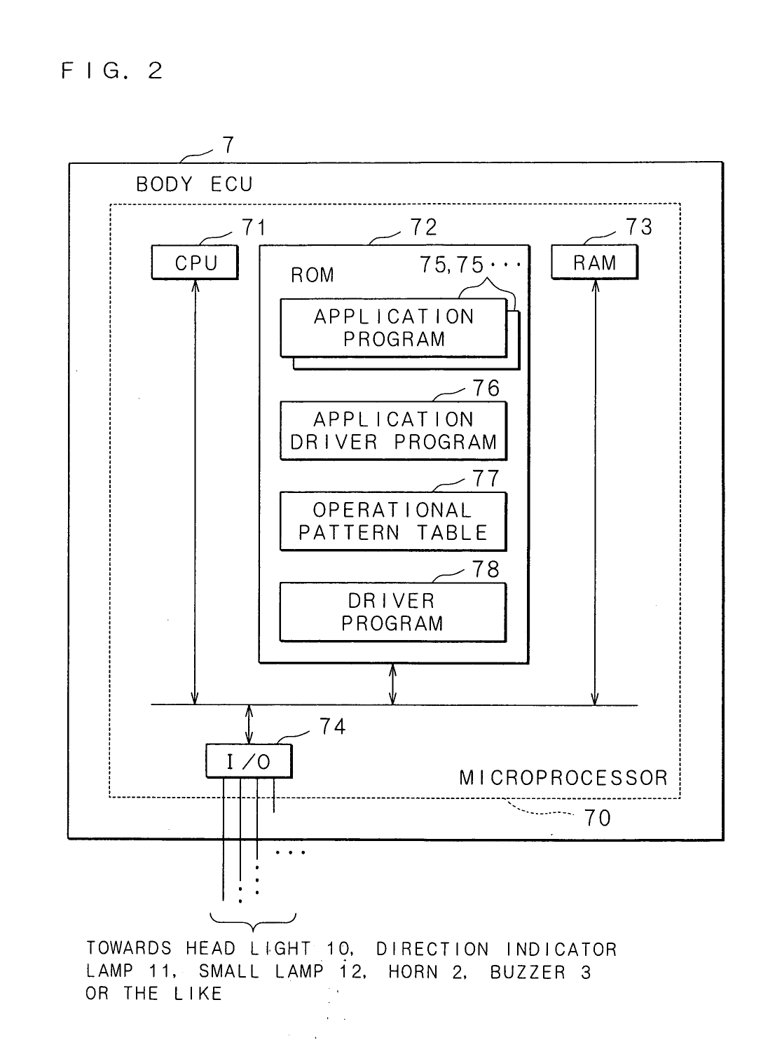

FIG. 2 is a block diagram showing an inner configuration of the body ECU 7 included in the control system adapting for motor vehicle according to the embodiment 1. The body ECU 7 is configured to include a microprocessor 70 containing a CPU 71, ROM (storage unit; storage means) 72, RAM (Random Access Memory) 73 and an I/O 74. The microprocessor 70 may be provided a network controller and/or a transceiver exteriorly and/or interiorly, in a case that the microprocessor 70 is connected via an on-board network to sensors, such as the door open/close sensors 4, 4, the door lock sensors 5, 5, and the key sensor 6.

The CPU 71 reads out computer program stored on the ROM 72, loads the read computer program onto the RAM 73 and executes the loaded computer program, to implement the keyless answerback function or the security answerback function described above.

A flash memory is utilized as the ROM 72. The ROM 72 stores application program 75, 75, application driver program (computer program) 76 and driver program 78, as computer program being read out and executed by the CPU 71. In addition, the ROM 72 stores an operational pattern table 77 referred by the CPU 71 for identifying operation contents of all controlled objects. Although the ROM 72 is primarily in a form of a read-only-memory, it is possible to rewrite information on the ROM 72 if an update of the computer program to be executed by the CPU 71 or an update of the operational pattern table 77 is required.

A DRAM (Dynamic RAM), SRAM (Static RAM) or the like is utilized as the RAM 73. The RAM 73 not only loads the computer program being read out by the CPU 71 but also temporally stores a variety of information generated by processes.

The I/O 74 is an interface between the microprocessor 70 and the external objects. The CPU 71 outputs control signals from the I/O 74 to the head lights 10, 10, direction indicator lamps 11, 11, small lamps 12, 12, horn 2 or the buzzer 3.

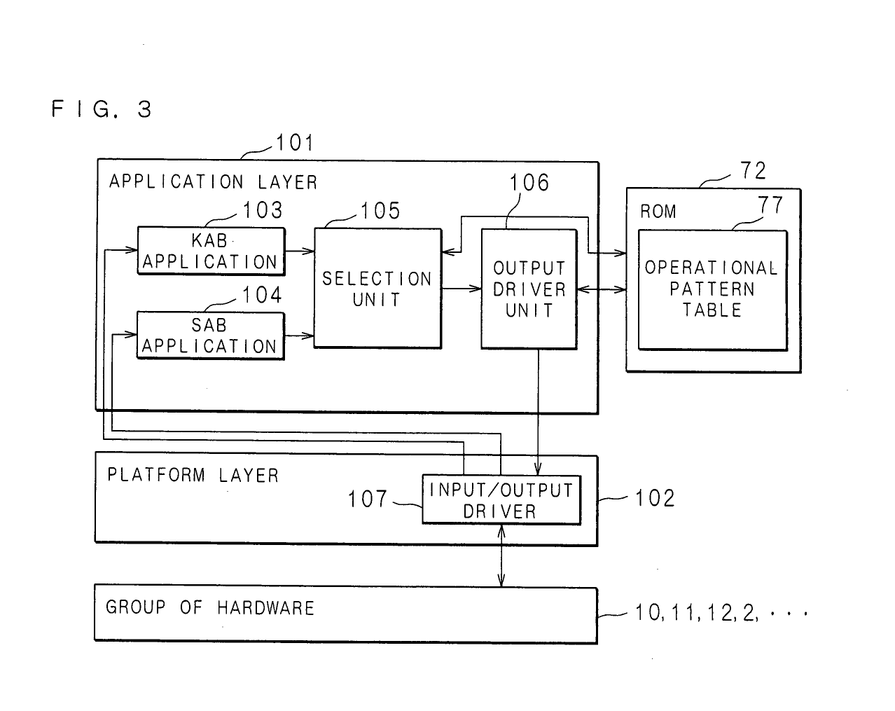

Next, descriptions will be given about detailed functions within the microprocessor 70 implemented by the computer program that the CPU 71 of the microprocessor 70 reads out from the ROM 72. FIG. 3 is a function block diagram conceptually showing functions implemented by the CPU 71 of the microprocessor 70 included in the body ECU 7 according to the embodiment 1.

The CPU 71 performs processes with a software structure separated into layers, such as an application layer 101 and a platform layer 102, through reading out and executing the application program 75, 75, . . . , application driver program 76 and the driver program 78 stored on the ROM 72.

The CPU 71 functions as an application implementing the keyless answerback function, i.e., KAB (Keyless Answer Back) application 103, when performing processes based on a keyless answerback application program 75 among the application program 75, 75, . . . . Similarly, the CPU 71 functions as an application implementing the security answerback function, i.e., SAB (Security Answer Back) application 104, when performing processes based on a security answerback application program 75 among the application program 75, 75, . . . . Both the functions as KAB application 103 and SAB application 104 are structurally positioned in the application layer 101.

The CPU 71 implements functions as a selection unit (selection means) 105 and as an output driver unit (output unit; output means) 106, based on the application driver program 76. The both functions as the selection unit 105 and the output driver unit 106 are not so-called driver functions that handle signals associated with a physical layer in order to directly control a group of hardware (controlled objects: i.e., the head light 10, direction indicator lamp 11, small lamp 12, horn 2, buzzer 3 and the like). Instead, the both functions as the selection unit 105 and the output driver unit 106 are modules that handle processes common in all the application as single common process. For example, these modules handle signal creation processes common even in the KAB application 103 and the SAB application 104 as single common process. In addition, the both functions as the selection unit 105 and the output driver unit 106 are positioned in the application layer 101.

Furthermore, the CPU 71 functions as an input/output driver 107 based on the driver program 78. A function of the input/output driver 107 implements a so-called driver function and actually inputs/outputs control signals associated with a physical layer to/from the I/O 74 in order to directly control the group of hardware. The function as the input/output driver 107 is structurally positioned in the platform layer 102.

The function of the CPU 71 as the selection unit 105 receives an operation request, identifies an controlled object and a specific operation performed by the identified controlled object, and gives the output driver unit 106 information about the identified controlled object and the specific operation contents, when the CPU 71 gives an operation request with utilizing the function as the KAB application 103 or the SAB application 104 to an controlled object hardware, for example, when the CPU 71 gives a lighting request to the head light 10.

The function of the CPU 71 as the output driver unit 106 creates a control signal based on the information about the controlled object and the specific operation performed by the identified controlled object for implementing the specific operation. Then, the function of the CPU 71 as the output driver unit 106 makes the input/output driver 107 in the platform layer 102 output the created control signal to the controlled object hardware.

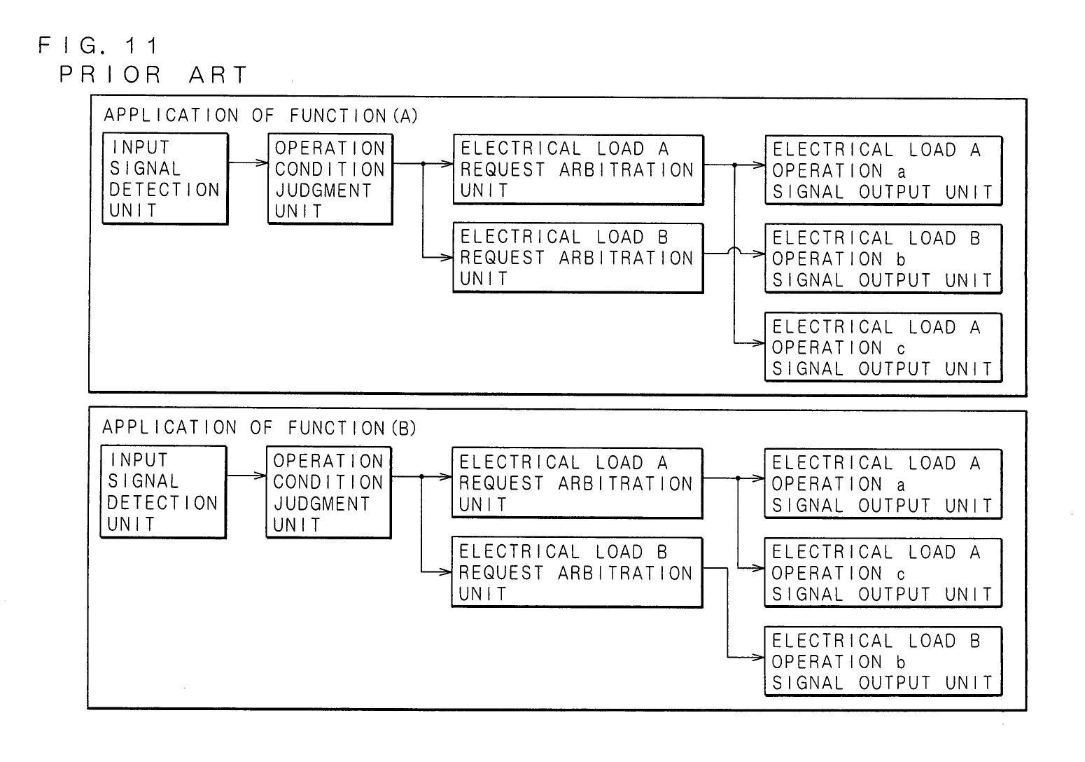

Thus, the body ECU 7 according to the embodiment 1 utilizes a configuration that the selection unit 105 receives operation requests of all applications and the function of the output driver unit 106 for creating control signals is shared with all the application, but not utilizes the configuration (shown in FIG. 11) that a control signal is created per all applications, such as the KAB application 103 and the SAB application 104, and per all controlled objects. In a case that controlled objects are controlled by switching between the on and off state in all applications, such as the KAB application 103 and the SAB application 104, all applications can share the process for creating the control signal based on the operation request because control signal creation processes substantially the same among all applications only with a few differences about detailed contents. In other words, it is possible for all loads to share the function as an output means that creates a control signal based on an operation content of a selected load and outputs the created control signal to the selected load, without identifying the application generating an operation request. Furthermore, the body ECU 7 sequentially implements a function of each application, without simultaneously controlling some controlled object hardware. Thus, it is not required to utilize a configuration performing control signal creation processes simultaneously. Therefore, it is possible to share single control signal creation process among all applications. The configuration sharing such the single reusable process among all functions can reduce the occupied memory amounts in the ROM 72 and the RAM 73.

Specifically, it is required to provide an executable file (program code) corresponding to each function shown by each block in FIG. 3, for the CPU 71 to implement each function. Because the function for the process selecting a controlled object shares the single selection unit 105 and the single output driver unit 105 with the function for the process creating a control signal, this configuration requires smaller memory capacity for the ROM 72 and the RAM 73 than a configuration that executes many application driver program for many application program 75, 75, . . . . In other words, this advantage is provided since single program code is enough for the output driver unit 106 of the KAB application 103 and the output driver unit 106 of the SAB application 104 in the configuration according to the present invention. Furthermore, development of functions can be focused only on the application program 75, 75, . . . for generating operation requests, because each function to be implemented can reutilize the function of the selection unit 105 and the output driver unit 106 without having own control signal creation process. Therefore, it is possible to improve development efficiency.

The CPU 71 in the embodiment 1 refers the operational pattern table 77 previously stored on the ROM 72 to identify the operation contents with utilizing the function of the selection unit 105. The operational pattern table 77 keeps many operational patterns per controlled object hardware. The selection unit 105 gives, to the output driver unit 106, identification information for identifying an operational pattern with utilizing the operational pattern table 77. The output driver 106 then makes the input/output driver 107 output a control signal based on an operational pattern identified in accordance with the given identification information.

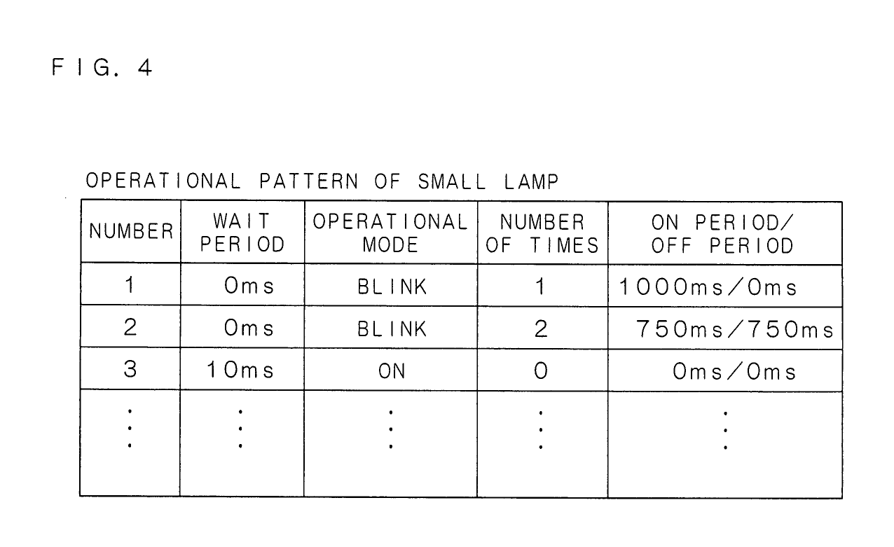

FIG. 4 is a view illustrating an example of an operational pattern table 77 stored on the ROM 72 of the body ECU 7 according to the embodiment 1. The operational pattern table 77 in the embodiment 1 keeps the operational patterns per controlled objects. FIG. 4 illustrates, as an example, about operational patterns of the small lamps 12, 12 as controlled objects.

Identification of an operational pattern is based on one of operation identification elements or from a combination of the operation identification elements including: wait period until starting and/or stopping an operation; an operational mode for representing whether an operation is continuously performed or unperformed; numbers of intermittently performed and/or unperformed operations; operation period for performing and/or un-performing an operation and the like. The operational patterns of the small lamps 12, 12 in FIG. 4 include: wait period until the “on” state, i.e., lighting; operational mode for representing whether an operation is continuous lighting or intermittent lighting, i.e., blinking; numbers of intermittent lighting; operation period for lighting and not-lighting. The operation performed by the small lamps 12, 12 is identified with utilizing these operation identification elements.

In the operational pattern table 77, each operational pattern is supplied with a number as identification information. In FIG. 4, an operational pattern “1” makes the small lamps 12, 12 light for “1000 ms (millisecond)” without waiting, in order to “blink” “one time”. An operational pattern “2” makes the small lamps 12, 12 repeat a sequence lighting for “750 ms” without waiting and non-lighting for “750 ms” in order to “blink” “two times”. An operational pattern “3” makes the small lamps 12, 12 continuously light after waiting for “10 ms” until an instruction of “off” state.

With utilizing the function as the selection unit 105, the CPU 71 selects the operational pattern “1” for the small lamps 12, 12 in FIG. 4, for example, when receiving a one-time blinking request for the small lamps 12, 12 generated by a notification “the doors are locked” performed by the function of the KAB application 103. With utilizing the function as the selection unit 105, the CPU 71 then gives information representing the small lamps 12, 12 (e.g., a number of the controlled object) and the number of the selected operational pattern (“1”), to the output driver unit 106. Alternatively, the function of the selection unit 105 may receive only a notice request about “the doors are locked”, and then an operation in response to the notice request about “the doors are locked” may be performed to identify the operational pattern “1” and output the number of the selected operational pattern (“1”).

With utilizing the function as the output driver unit 106, the CPU 71 refers to the operational pattern table 77, identifies the pattern making the small lamps 12, 12 light for “1000 ms (millisecond)” without waiting in order to “blink” “one time” based on the information representing the small lamps 12, 12 and the identification information “1” about operational pattern given by the selection unit 105, and makes the input/output driver 107 output a control signal corresponding to the identified pattern.

As described above, the CPU 71 refers the operational pattern table 77 and identifies operation contents, with utilizing the functions as the selection unit 105 and the output driver unit 106. Therefore, it is possible to simplify the operations and reduce complications of the device/apparatus. Furthermore, the operational pattern table 77 can be utilized to convert the specific operations. Therefore, it is possible to implement various operations flexibly. Moreover, with a configuration that a specific operation is performed per loads, the operational pattern table is required to keep only minimum operational patterns per loads. Therefore, it is possible to save memory capacity occupied by the operational pattern table.

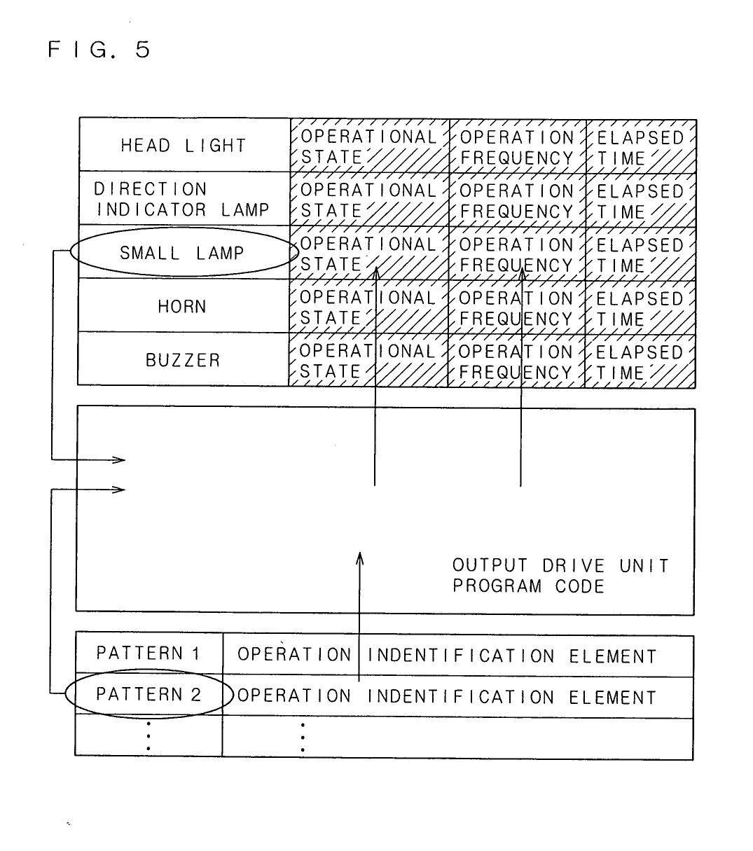

Next, it will be described about detailed processes of the CPU 71 implemented by the output driver unit 106. FIG. 5 is a view illustrating an example of a process in a case of the CPU 71 functioning as the output driver unit 106. In FIG. 3, each block represents information occupying the RAM 73, when the CPU 71 functions as the output driver unit 106.

In the upper section of FIG. 5, specific parameters per controlled objects are stored that represent an operational state, operation frequency and elapsed time of an operation, for the objects controlled by the body ECU 7, i.e., the head lights 10, 10, direction indicator lamps 11, 11, small lamps 12, 12, horn 2 and buzzer 3. Alternatively, operational states may be stored per the controlled objects and per application programs requesting operations to the controlled objects. The operational state represents any one of states, such as “stop”, “on (lighting)” and “off (not-lighting)”. The frequency represents a number of times for an intermittent operation, e.g., a present number of blinking times. It should be noted that it is possible to change at any time the contents of hatched blocks about operational state, operation frequency and elapsed time.

The lower section of FIG. 5 shows the operational pattern table 77. Although the operational pattern table 77 is stored on the ROM 72, the operational pattern table 77 on the RAM 73 shown in FIG. 5 is information temporally extracted by the CPU 71 and is a part of the operational pattern table 77 stored on the ROM 72.

The middle section in FIG. 5 shows a loaded program code corresponding to the output driver unit 106. A controlled object to be provided with an output control signal is identified by the program code with utilizing information that is configured from the information representing a controlled object and the identification information for identifying an operational pattern given by the selection unit 105. A control signal based on the operational state is created by comparison between the operational state and operation frequency identified with specific parameters of identified controlled object and the operation identification elements of identified operational pattern. Next, the operational state and the operation frequency are changed and then another process is performed for another operation request regarding another controlled object.

In the configuration of the embodiment 1, the control signal creation process is implemented for a plurality of controlled objects by single program code, instead of many program codes that are expanded for many output driver units 106 with respect to many controlled objects or many application program 75, 75, . . . . In other words, in the configuration of the embodiment 1, the output unit creates a control signal per operations of the controlled object devices, on the basis of single program code. Thus, it is not required to re-load another program code on the RAM 73 for other controlled objects or other application programs 75, 75, . . . . Therefore, it is possible to save memory and reduce complications of the apparatus.

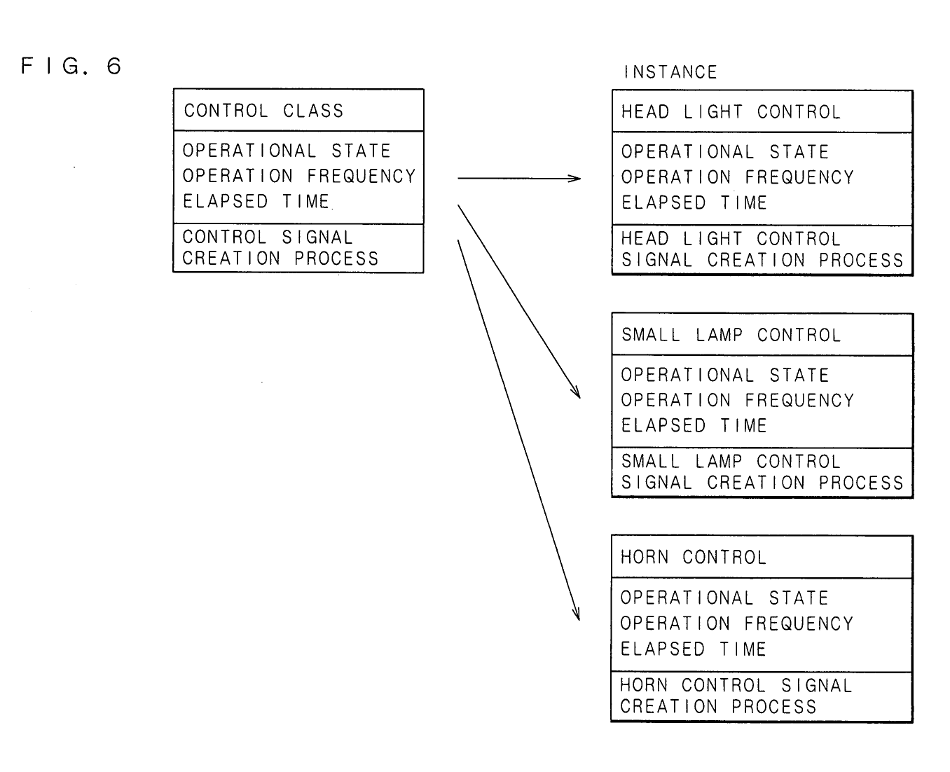

FIG. 6 is a view illustrating an example of implementation, as a comparative example, for an object-oriented type of program performing a control process per controlled objects. The left section in FIG. 6 shows a definition of control class utilizing a shared control signal creation process corresponding to a process of the output driver unit 106. The control class has specific parameters as the operational state, operation frequency and the elapsed time. In the control signal creation process, these specific parameters are internally handled as variable information. Instances of the control class are created for all controlled objects, and then program codes are created for actually implementing operations of all controlled objects as shown the right section in FIG. 6. In the example of FIG. 6, the instantiation is motor carried out for the head light control, small lamp control and the horn control. In the configuration of FIG. 6, the instantiation is performed separately for all control signal creation processes of the head light control, small lamp control and the horn control, although the control signal creation processes are substantially the same among the head light control, small lamp control and the horn control. Thus, memory is allocated for all the instantiation processes, and happens to have capacity occupied by the created program codes with approximately three times larger than the case of FIG. 5.

In the configuration of the embodiment 1, the specific parameters for all controlled objects are changed with utilizing single program code on the basis of the progress status, and then each operation request generated by an application is sequentially motor carried out. Thus, in consideration of the object-oriented type concept, the instantiation process of the class utilizing single sharable control process can be motor carried out for all controlled objects. Therefore, even with utilizing the embedding type of computer program and the limited memory capacity, it is possible to implement the processes having the sharable single process of the class to the specific parameters of all controlled objects. In the configuration of the embodiment 1, the sharable single program code is stored on the memory, instead of many program codes according to all loads and all functions for creating and outputting control signals. Thus, the configuration of the embodiment 1 can reduce the occupied memory capacity. Therefore, it is possible to reduce complications of the apparatus, through saving the memory. Furthermore, the configuration of the embodiment 1 does not require many output means according to the actual load controls for all functions to be implemented, because re-using the function of the shared output means. Thus, the developments of the control system and the control apparatus can be focused on the development of the application program, if the developments meet the configuration that can identity operation contents corresponding to the function to be implemented without discriminating outputs for loads. Therefore, it is possible to improve the development efficiency.

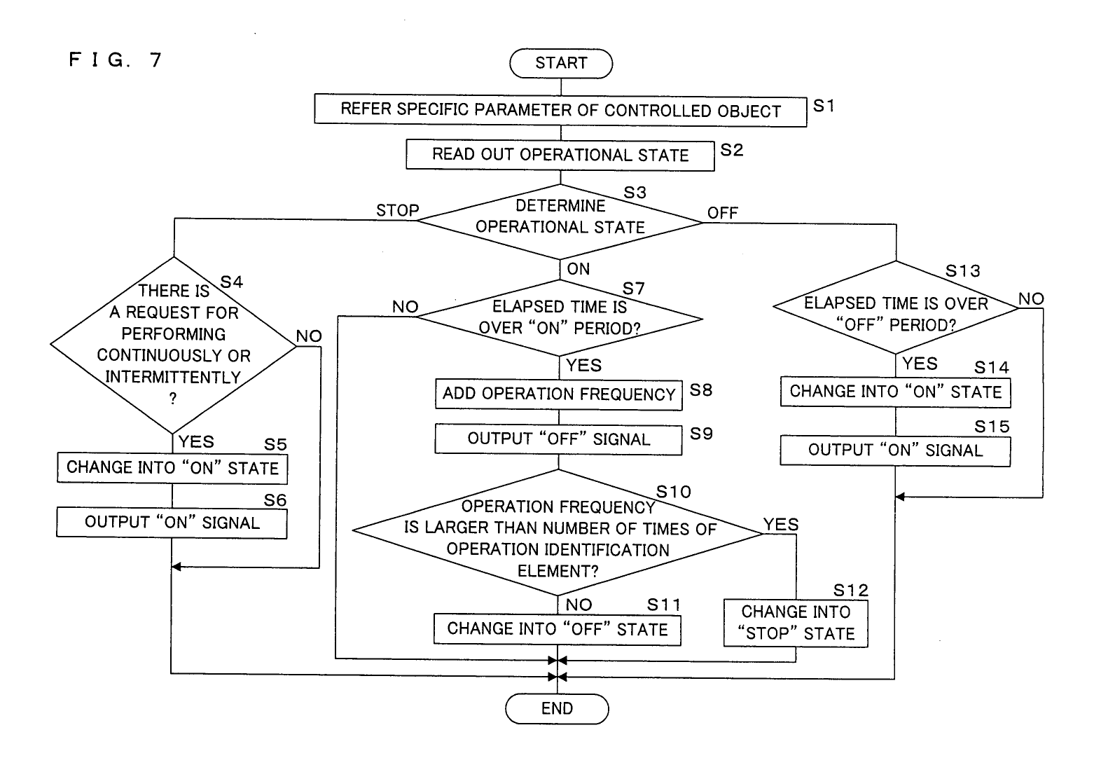

FIG. 7 is a flowchart illustrating an example of implementation for a procedure in a case of the CPU 71 functioning as the output driver unit 106. The CPU 71 performs a procedure described below on the basis of the single program code expanded on the memory as shown in FIG. 5, when receiving information about the controlled object sent from the selection unit 105 that obtains the operation request and receiving information about the operational pattern according to the operation to be performed by the controlled object. After terminating the procedure showed by the flowchart described below, the CPU 71 waits for a predetermined period, then re-starts the procedure, and performs properly each process at each time based on the status, such as the operational state and the elapsed time. In the procedure described below, the small lamps 12, 12 are illustrated as examples for the controlled objects.

The CPU 71 refers the memory (step S1) storing specific parameters of the small lamps 12, 12, and reads out an operational state from the specific parameters (step S2), on the basis of receiving information about controlled objects (i.e., the small lamps 12, 12 in this case).

The CPU 71 determines whether the operational state being read out at the step S2 is “stop”, “on (lighting)” or “off (not-lighting)” (step S3). When having determined that the operational state is “stop”, the CPU 71 proceeds the procedure to step S4. When having determined that the operational state is “on”, the CPU 71 proceeds the procedure to step S7. When having determined that the operational state is “off”, the CPU 71 proceeds the procedure to step S13.

When having determined at the step S3 that the present operational state contents of the operation request for the small lamps 12, 12 are “stop” (S3: “stop”), the CPU 71 decides whether there is a request for performing continuously or intermittently, or not (step S4). When having decided that there is a request for performing continuously (i.e., lighting of the small lamps 12, 12, in this case) or intermittently (i.e., blinking of the small lamps 12, 12, in this case) (S4: YES), the CPU 71 changes the operational state of the controlled objects (i.e., the small lamps 12, 12) into “on” (i.e., lighting) state (step S5), instructs the input/output driver 107 to actually output “on” signals to the small lamps 12, 12 (step S6), and then terminates the procedure.

When having decided at the step S4 that there is no request for performing continuously or intermittently (S4: NO), the CPU 71 terminates the procedure in order to keep the “stop” state.

When having determined that the present operational state is “on (lighting)” (S3: “on/lighting”), the CPU 71 reads out time elapsed after the present “on” state (i.e., time elapsed after the present “on/lighting” state of the small lamps 12, 12 according to the blinking or lighting request), from the specific parameters of the controlled objects according to the operation request. The CPU 71 then decides whether the read elapsed time is over “on” period represented by the operation identification elements of the given operational pattern or not (step S7).

When having decided that the read elapsed time is over the “on” period (S7: YES), the CPU 71 adds the operation frequency (i.e., number of blinking times, in this case) (step S8) and instructs the input/output driver 107 to actually output an “off” signal to the small lamps 12, 12 (step S9), in a case that the operation manner represented by the operation identification elements of the given operational pattern is for performing intermittently.

Next, the CPU 71 decides whether the operation frequency added at the step S8 (i.e., number of blinking times, in this case) is larger than an operation number of times read out from the operation identification elements of the given operational pattern, or not (step S10). When deciding at the step S10 that the operation frequency is not larger than the operation number of times (S10: NO), the CPU 71 changes the operational state contents of the controlled objects (i.e., the small lamps 12, 12, in this case) into the “off/un-lighting” state (step S11) in order to keep the intermittent performance (i.e., blinking operation) and terminates the procedure. When having decided at the step S10 that the operation frequency is larger than the operation number of times (S10: YES), the CPU 71 changes the operational state contents into the “stop” state (step S12) in order to end the intermittent performance (i.e., blinking operation) and terminates the procedure.

When having decided at the step S7 that the read elapsed time is not over the “on” period (S7: NO), the CPU 71 ends the processing for keeping the “on” (i.e., lighting) state.

When having determined at the step S3 that the present operational state is “off (un-lighting)” (S3: “off/un-lighting”), the CPU 71 reads out time elapsed after the present “on” state (i.e., time elapsed after the present “off/un-lighting” state of the small lamps 12, 12 according to the blinking or lighting request), from the specific parameters of the controlled objects according to the operation request. The CPU 71 then decides whether the read elapsed time is over “off” period represented by the operation identification elements of the given operational pattern or not (step S13).

When having decided at step S13 that the read elapsed time is over the “off” period (S13: YES), the CPU 71 changes the operational state of the controlled objects (i.e., small lamps 12, 12) into the “on” (i.e., lighting) state (step S14) and instructs the input/output driver 107 to actually output an “on” signal to the small lamps 12, 12 (step S15).

When having decided at the step S13 that the read elapsed time is not over the “off” period (S13: NO), the CPU 71 terminates the procedure in order to keep the “off” state.

As described above, the operational state, operation number of times and the elapsed time are changed after being read out from the specific parameters of each controlled object. Therefore, it is possible to perform the object-oriented type procedure that can implement a function per application programs generating operation requests for many controlled objects. In consideration of cyclical and rapid performance of procedures, a single program code may be applied to an ECU adapting for motor vehicle. Thus, when utilizing the configuration described above that the single program code of the application driver program 76 corresponds to many controlled objects and many control processes based on the application programs 75, 75, . . . for implementing many functions, the ECU adapting for motor vehicle can reduce memory capacity occupied by the program codes with respect to the RAM 73 during execution, and does not require a complicated management for memory because of no need to allocate memory capacity dynamically. Therefore, the configuration of the embodiment 1 is suitable for the procedure performed by an ECU based on a microprocessor, such as the ECU adapting for motor vehicle.

As described above, it is possible to save the memory capacities of the ROM 72 and RAM 73. Therefore, it is possible to reduce complications of the inner configuration of the body ECU 7. Furthermore, the function of application driver program 76 can be shared, instead of requiring programs corresponding to the application driver program 76 for all functions to be implemented by the body ECU 7. Thus, the developments of the control system and the control apparatus can be focused on the developments of the application programs 75, 75, . . . , in consideration of an interface for the function of the selection unit 105. Therefore, it is possible to improve the development efficiency.

### Embodiment 2

The embodiment 1 Utilizes the Operational Pattern Table 77 that has a list showing several operational patterns per controlled objects, as shown in FIG. 4. On the other hand, an embodiment 2 utilizes the operational pattern table 77 that shows contents of each operation identification element for identifying an operational pattern. In the embodiment 2, each controlled object utilizes a specified operational pattern table 77.

A control system adapting for motor vehicle in the embodiment 2 is configured similarly to the control system in the embodiment 1, except for contents of the operational pattern table 77. Thus, it will be described with the same numeral as the embodiment 1 about configuration similar to the embodiment 1, and explained about the contents of the operational pattern table 77 and the identification method of the operational pattern with utilizing the operational pattern table 77 different between the embodiment 1 and the embodiment 2.

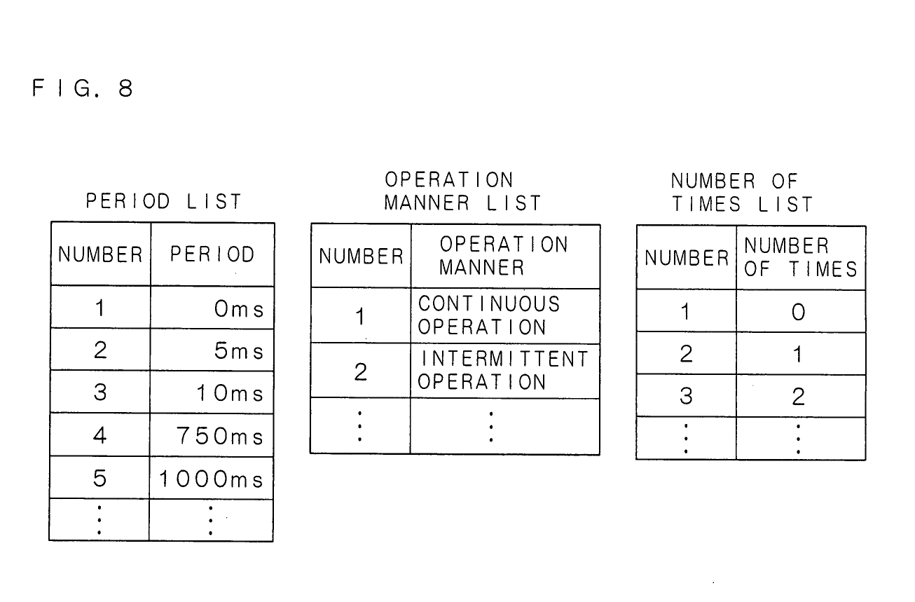

FIG. 8 is a view illustrating an example of the operational pattern table 77 stored on a ROM 72 of an body ECU 7 according to the embodiment 2. As shown in FIG. 8, the operational pattern table 77 in the embodiment 2 has a list per operation identification elements, such as a period list, operation manner list and a number of times list. Thus, an operation identification element can be identified from the lists through a selection of number.

In the example of FIG. 8, the period list includes identification information, such as “0 ms” and “5 ms”, that can be selected by a number, in order to identify contents about wait period or on/off period. The operation manner list includes operation manner information, such as continuous performance and intermittent performance, that can be selected by a number. It should be noted that a particular operation is lighting in a case of the continuous performance selected as the operation manner for the small lamps 12, 12, and that a particular operation is blinking in a case of the intermittent performance selected as the operation manner for the small lamps 12, 12. The number of times list includes information, such as “0”, “1”, and “2”, that can be selected by a number in order to identify contents.

For example, with utilizing the operational pattern table 77 shown in FIG. 8, the operational pattern “1” shown in FIG. 4 can be represented by a parameter ([wait period, operation manner, number of times, on-period, off-period]=[1, 2, 2, 5, 1]): wait period “1”, operation manner “2”, number of times “2”, on-period “5” and off-period “1”, in order to give information for identifying an operational pattern to the output driver unit 106.

The operational pattern table 77 in the embodiment 2 can save the ROM 72 much further and be effective. In the configuration according to the embodiment 1 that previously store operational patterns per loads, a required new operational pattern should be added to the operational pattern table 77. However, in the configuration according to the embodiment 2, the function of the selection unit 105 for each controlled object can select free operational patterns. Therefore, it is possible to implement various operations.

### Alternative Embodiment

The CPU 71 of the microprocessor 70 in the body ECU 7 described above may perform a procedure described below, with utilizing the function as the selection unit 105. Specifically, the selection unit 105 adds a new operational pattern after confirming that the new operational pattern is not included in the operational pattern table 77, when a new operation request is generated by an application based on the KAB application 103, SAB application 104 or another application program 75.

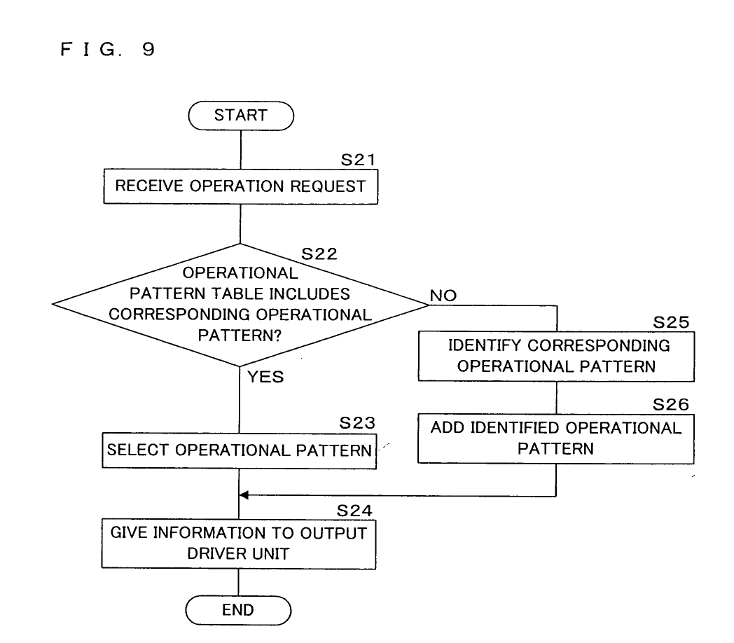

FIG. 9 is a flowchart illustrating an example of a procedure that a CPU 71 functioning as a selection unit 105 adds a new operational pattern corresponding to an operation request onto an operational pattern table 77.

The CPU 71 receives an operation request generated by each application based on application programs 75, 75, . . . including the KAB application 103 and the SAB application 104, with utilizing the function as the selection unit 105 (step S21). The CPU 71 decides whether the operational pattern table 77 includes an operational pattern corresponding to the received operation request, or not (step S22).

When having decided that the operational pattern table 77 includes an operational pattern corresponding to the received operation request (S22: YES), the CPU 71 selects the corresponding operational pattern (step S23), gives information for identifying the selected operational pattern to the output driver unit 106 (step S24), and terminates the procedure.

When having decided that the operational pattern table 77 does not include an operational pattern corresponding to the received operation request (S22: NO), the CPU 71 identifies the operational pattern corresponding to the received operation request (step S25). For example, when the operation request represents a command, such as “blink (parameter according to number of times)” which can discriminate “request for two times blinking”, the decision may be performed through checking whether there is an operational pattern about “two” times “blinking” per controlled objects in the operational pattern table 77 configured to have contents per controlled objects. Alternatively, the decision may be performed through checking whether there is information corresponding to the “2” in the number of times list in the operational pattern table 77 configured to have contents per operation identification elements.

The CPU 71 creates and adds the operational pattern identified at the step S25 (step S26), gives information for identifying the added operational pattern to the function of the output driver unit 106 (S24), and terminates the procedure.

When the new operational pattern is added at the step S26 with the operational pattern table 77 configured to store operational patterns per controlled objects, new operation identification elements are respectively set and added for the identified operational pattern, in addition to applying new numbers. Alternatively, in the case of the operational pattern table 77 configured to store a list per operation identification elements, new information may be added onto any of the lists. For example, when the operation request represents operational pattern about “two” times “blinking”, “2” may be added at the step S26 to the number of times list that does not have the information “2”.

The function of the selection unit 105 is configured to allow the operational pattern table 77 to update the contents. Therefore, it is possible to implement various operations, with the configuration that can save memory and perform the object-oriented procedure.

The CPU 71 of the microprocessor 70 in the body ECU 7 may be configured to perform a procedure described below, with utilizing the function as the selection unit 105. Specifically, the selection unit 105 preferentially receives an operation request generated by an application having a higher priority, when operation requests are generated simultaneously by applications based on the KAB application 103, SAB application 104 or another application program 75.

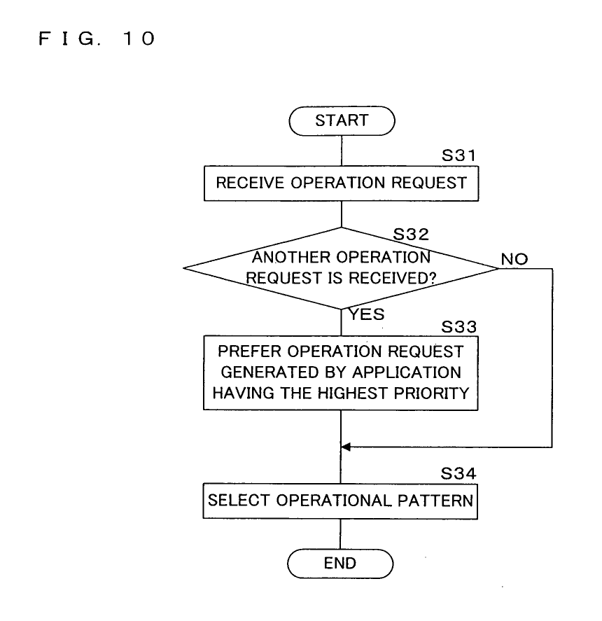

FIG. 10 is a flowchart illustrating an example of the procedure that the CPU 71 preferentially selects a controlled object and an operation based on a priority of an application program generating an operation request.

The CPU 71 receives an operation request generated by an application based on each of the application programs 75, 75, including the KAB application 103 or SAB application 104, with utilizing the function as the selection unit 105 (step S31).

The CPU 71 decides whether receiving another operation request from another application or not (step S32). When having decided to receive another operation (S32: YES), the CPU 71 prefers the operation request generated by the application having the highest priority among the applications generating operation requests (step S33). Un-preferred operation request is held.

The CPU 71 selects an operational pattern corresponding to the preferred operation request (step S34), and terminates the procedure. Then, the CPU 71 performs a procedure according to the flowchart shown in FIG. 7 of the embodiment 1.

When having decided not to receive another operation request (S32: NO), the CPU 71 selects an operational pattern corresponding to the operation request received at the step S31 (S34), terminates this procedure, and performs the procedure according to the flowchart shown in FIG. 7.

Thus, a single shared function can be reutilized for the functions of the selection unit 105 and the output driver unit 106 in the application layer 101, and the selection of function can be performed on the basis of priority level among the functions corresponding to the application programs 75, 75, . . . . It should be noted that the output driver unit 106 does not require a decision about a load to be output signal preferably. The priority level can be changed by the selection unit 105 that receives all operation requests. Therefore, the software configuration in this embodiment leads advantages about flexibility.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A control system, comprising:
a plurality of controlled object devices; and
a control apparatus connected to the plurality of controlled object devices, wherein
the control apparatus comprises:
a microprocessor that performs a plurality of processes based on a plurality of application programs;
a selection unit that identifies an controlled object device corresponding to a process performed by the microprocessor and selects an operation of the identified controlled object device; and
an output unit that creates and outputs a control signal for performing the operation selected by the selection unit, to the identified controlled object device, wherein
the identified controlled object device performs the operation corresponding to the control signal outputted by the output unit; and
the output unit creates a control signal per operations of the controlled object devices, on the basis of single program code.

2. A control system according to claim 1, wherein
the control apparatus further comprises a storage unit that stores a table showing a plurality of operational patterns, wherein
the selection unit selects the operation performed by the identified controlled object device based on the table.

3. A control system according to claim 2, wherein
the storage unit stores the table per the plurality of controlled object devices.

4. A control system according to claim 2, wherein
each operational pattern shown by the table is configured from one of operation identification elements or from a combination of a plurality of the operation identification elements, the operation identification elements comprising:
a wait period until starting and/or stopping an operation;
an operational mode for representing whether an operation is continuously performed or unperformed;
numbers of intermittently performed and/or unperformed operations; and
an operation period for performing and/or unperforming an operation; and
the storage unit stores the table per the operation identification elements.

5. A control apparatus that outputs a control signal for controlling an operation performed by a plurality of controlled object devices connected thereto, comprising:
a microprocessor that performs a plurality of processes based on a plurality of application programs;
a selection unit that selects an operation corresponding to a process performed by the microprocessor; and
an output unit that creates and outputs a control signal for performing the operation selected by the selection unit, wherein the output unit creates a control signal per operations of the controlled object device, on the basis of single program code.

6. A control apparatus according to claim 5, further comprising:
a storage unit that stores a table showing a plurality of operational patterns, wherein
the selection unit selects the operation performed by the identified controlled object device based on the table.

7. A control apparatus according to claim 5, wherein
priorities are assigned to the plurality of application programs; and
the microprocessor performs processes based on an application program having the highest priority among the plurality of application programs.

8. A control apparatus according to claim 6, wherein
when the table does not show an operational pattern corresponding to a process performed by the microprocessor, the selection unit adds the operational pattern not shown by the table onto the table.

9. A control apparatus according to claim 6, wherein
each operational pattern shown by the table is configured from one of operation identification elements or from a combination of a plurality of the operation identification elements and has identification information, the operation identification elements comprising:
a wait period until starting and/or stopping an operation;
an operational mode for representing whether an operation is continuously performed or unperformed;
numbers of intermittently performed and/or unperformed operations; and
an operation period for performing and/or unperforming an operation.

10. A control apparatus according to claim 9, wherein
a plurality of tables are stored by the storage unit, on the basis of numbers of the connected controlled object devices; and
the selection unit selects the operation based on a table chosen from the plurality of tables and the identification information.

11. A control apparatus according to claim 9, wherein
the storage unit stores the table per the operation identification elements;
the selection unit selects the operation based on a table chosen from tables stored by the storage unit and the identification information.

12. A control method for controlling operations of plural devices with using a microprocessor having a plurality of application programs, comprising steps of:
performing processes based on an application program;
receiving an operation request generated through performing the processes;
identifying a device corresponding to the received operation request;
selecting an operation, based on the received operation request, corresponding to the identified device;
creating a control signal for performing the selected operation;
outputting the created control signal to the identified device; and
controlling an operation of the identified device through making the identified device perform an operation based on the outputted control signal, wherein
a control signal per the plural devices is created on the basis of single program code.

13. A control method according to claim 12, further comprising a step of:
preparing a table that shows a plurality of operational patterns per the plural devices, wherein
the operation performed by the identified controlled object device is selected on the basis of the table.

14. A control method according to claim 12, further comprising a step of:
preparing a table that shows a plurality of operational patterns per operation identification elements, each of the operation patterns being configured from one of the operation identification elements or from a combination of a plurality of the operation identification elements, the operation identification elements comprising:
a wait period until starting and/or stopping an operation;
an operational mode for representing whether an operation is continuously performed or unperformed;
numbers of intermittently performed and/or unperformed operations; and
an operation period for performing and/or unperforming an operation, wherein
the operation performed by the identified controlled object device is selected on the basis of the table.

15. A computer readable medium having stored thereon computer executable program for controlling operations of plural devices based on a plurality of application programs, wherein
the computer program when executed causes a computer system to execute steps of:
performing processes based on an application program;
receiving an operation request generated through performing the processes;
identifying a device corresponding to the received operation request;
selecting an operation, based on the received operation request, corresponding to the identified device;
creating a control signal for performing the selected operation;
outputting the created control signal to the identified device; and
controlling an operation of the identified device through making the identified device perform an operation based on the outputted control signal, wherein
a control signal per the plural devices is created on the basis of single program code.

16. A computer readable medium according to claim 15, wherein the computer program when executed causes the computer system to execute further a step of:
preparing a table that shows a plurality of operational patterns per the plural devices, wherein
the operation performed by the identified controlled object device is selected on the basis of the table.

17. A computer readable medium according to claim 15, wherein the computer program when executed causes the computer system to execute further a step of:
preparing a table that shows a plurality of operational patterns per operation identification elements, each of the operation patterns being configured from one of the operation identification elements or from a combination of a plurality of the operation identification elements, the operation identification elements comprising:
a wait period until starting and/or stopping an operation;
an operational mode for representing whether an operation is continuously performed or unperformed;
numbers of intermittently performed and/or unperformed operations; and
an operation period for performing and/or unperforming an operation, wherein
the operation performed by the identified controlled object device is selected on the basis of the table.
